(19) United States
(12) Patent Application Publication
(10) Pub. No.: US 2025/0251066 A1
(43) Pub. Date: Aug. 7, 2025

(54) OIL TUBING CONNECTOR

(71) Applicant: Guofen Luo, Dongguan City (CN)

(72) Inventor: Guofen Luo, Dongguan City (CN)

(21) Appl. No.: 18/430,667

(22) Filed: Feb. 2, 2024

(51) Int. Cl. F16L 33/18; F16L 33/30; F16L 43/00

(52) U.S. Cl. CPC F16L 33/18; F16L 33/30; F16L 43/008

(57) ABSTRACT

An oil tubing connector, comprising a tube body, an oil nozzle, and a connector head. A first connection structure is provided between the tube body and the oil nozzle, wherein the oil nozzle is snap-fitted to one end of the tube body through the first connection structure. A second connection structure is provided between the tube body and the connector head, wherein the connector head is snap-fitted to the other end of the tube body through the second connection structure. Both the first and second connection structures include a snap-fit component and a snap-fit slot, where the snap-fit component consists of two or more snap-fit pieces. The snap-fit slot of the first connection structure is formed by combining a first groove located on the tube body and a second groove located on the oil nozzle.

### FIELD OF THE INVENTION

The present invention relates to the technical field of oil tubing connectors, particularly to an oil tubing connector with good sealing performance.

### BACKGROUND OF THE INVENTION

In the current technology, oil tubing connectors are widely used in the field of component connections. Existing oil tubing connectors often comprise three parts: the tube body, the oil nozzle, and the connector head. The oil nozzle and the tube body are sealed with a sealing ring and fixed by a pin. Such a structural approach generally results in oil leaks between the oil nozzle and the tube body, with oil easily spilling from the gaps between them. Additionally, the assembly is cumbersome, requiring the use of a pin to fix the oil nozzle to the tube body or the connector head to the tube body. Holes for the pins must be drilled in the tube body, oil nozzle, and connector head, making the production process complicated, increasing manufacturing costs, and not conducive to mass production, lacking market competitiveness and practicality.

Therefore, in view of the common phenomenon of oil leaks between the oil nozzle and the tube body in the existing technology, the ease with which oil spills from the gaps between them, and the cumbersome assembly requiring pins to fix the oil nozzle to the tube body or the connector head to the tube body, where holes for the pins must be drilled in the tube body, oil nozzle, and connector head, complicating the production process and increasing manufacturing costs, which is not conducive to mass production and lacks market competitiveness, it is necessary to propose a technical solution for an oil tubing connector with good sealing performance.

### SUMMARY OF THE INVENTION

In view of this, it is necessary to provide an oil tubing connector with good sealing performance to at least address the issues present in related technologies where oil leaks commonly occur between the oil nozzle and the tube body, oil easily spills from the gaps between them, and the assembly is cumbersome. It requires the use of a pin to fix the oil nozzle to the tube body or the connector head to the tube body, necessitating the drilling of pin holes in the tube body, oil nozzle, and connector head, complicating the production process, increasing manufacturing costs, not conducive to mass production, lacking market competitiveness.

The present invention proposes an oil tubing connector with good sealing performance, comprising a tube body, an oil nozzle, and a connector head. A first connection structure is provided between the tube body and the oil nozzle, with the oil nozzle being snap-fitted to one end of the tube body through the first connection structure. A second connection structure is provided between the tube body and the connector head, with the connector head being snap-fitted to the other end of the tube body through the second connection structure. Both the first and second connection structures include a snap-fit component and a snap-fit slot, where the snap-fit component is composed of two or more snap-fit pieces. The snap-fit slot of the first connection structure is formed by a first groove located on the tube body and a second groove located on the oil nozzle, while the snap-fit slot of the second connection structure is formed by a third groove located on the tube body and a fourth groove located on the connector head. The first connection structure also includes a first seal groove, a first sealing ring, a second seal groove, and a first sealing element, with the first seal groove located on the tube body and the second seal groove located on either the tube body or the oil nozzle.

In one embodiment, the first sealing ring is fitted at the first seal groove, forming a first sealing structure between the tube body and the oil nozzle.

In another embodiment, the first sealing element includes any of the following: a second sealing ring, a sealing gasket, or a sealing sleeve.

In another embodiment, the second sealing ring, sealing gasket, or sealing sleeve is placed in the second seal groove, forming a second sealing structure between the tube body and the oil nozzle.

In another embodiment, the snap-fit component has a petal-like structure, with the snap-fit pieces including an L-shaped insertion part and a bending part, where the bending part extends outward.

In another embodiment, the snap-fit pieces are made of elastic metal.

In another embodiment, the first groove is located on the outer surface of the tube body, the second groove is located on the inner surface of the oil nozzle, with a first limit slot set inwardly on the first groove, and the protruding part of the L-shaped insertion part fitting into the first limit slot of the first groove. A second limit slot set outwardly is on the second groove, with the bending part located at the second limit slot.

In another embodiment, the third groove is located on the outer surface of the tube body, the fourth groove is located on the inner surface of the connector head, with a third limit slot set inwardly on the third groove, and the protruding part of the L-shaped insertion part fitting into the third limit slot of the third groove. A fourth limit slot set outwardly is on the fourth groove, with the bending part located at the fourth limit slot.

In another embodiment, the second connection structure also includes a third seal groove and a third sealing ring, with the third seal groove located on the tube body, and the second sealing ring fitted on the tube body, forming a third sealing structure between the tube body and the connector head.

In another embodiment, the outer surface of the oil nozzle is provided with an external thread, and the inner surface of the connector head is provided with an internal thread.

Advantageous Effects of the Invention: The present invention, by adopting a snap-fit component and slot fixing structure to replace the original pin and pinhole fixing structure, reduces the number of processing steps, provides better leak prevention, improves aesthetic appearance, lowers manufacturing costs and assembly difficulty, and facilitates installation. At the same time, it enhances the sealing performance of the tube body, oil nozzle, and connector head. Additionally, on the basis of the original sealing rings on the tube body or oil nozzle, sealing grooves are added, with sealing rings, sealing gaskets, or sealing sleeves placed in these grooves for secondary sealing. The connection design of the snap-fit components and slots results in a compact connection between the tube body and the oil nozzle, ensuring consistency and integrity, significantly improving the sealing performance between the tube body and the oil nozzle. The sealing effect is enhanced, effectively preventing oil spills from the gaps between the tube body and the oil nozzle, and offering strong practicality.

### BRIEF DESCRIPTION OF THE DRAWINGS

FIG. 1 is a schematic diagram of the overall structure of an embodiment of the present invention;

FIG. 2 is a schematic diagram of a partial structure of an embodiment of the present invention;

FIG. 3 is a schematic diagram of the structure of the tube body in an embodiment of the present invention;

FIG. 4 is a cross-sectional view of an embodiment of the present invention;

FIG. 5 is a schematic diagram of the structure of the snap-fit piece in an embodiment of the present invention;

FIG. 6 is a schematic diagram of the structure of the snap-fit slot of the first connection structure in an embodiment of the present invention;

FIG. 7 is a schematic diagram of the structure of the snap-fit slot of the second connection structure in an embodiment of the present invention.

### DETAILED DESCRIPTION OF THE EMBODIMENTS

The following description, in conjunction with the drawings of embodiments of the present invention, will provide a clear and complete description of the technical solutions in the embodiments of the invention. It is evident that the described embodiments are only part of the embodiments of the invention, not all of them. All other embodiments obtained by those skilled in the art based on the embodiments of the invention, without creative efforts, fall within the scope of protection of the invention.

It should be noted that when a component is described as “mounted on” another component, it can be directly mounted on the other component or may have intervening components. When a component is considered “set on” another component, it can be directly set on or may also have intervening components. When a component is considered “fixed to” another component, it can be directly fixed to the other component or may have intervening components.

Unless defined otherwise, all technical and scientific terms used herein have the same meaning as commonly understood by one of ordinary skill in the art to which this invention belongs. The terms used in the specification of the present invention are for the purpose of describing particular embodiments only and are not intended to limit the invention. The term “and/or” used herein includes any and all combinations of one or more of the associated listed items.

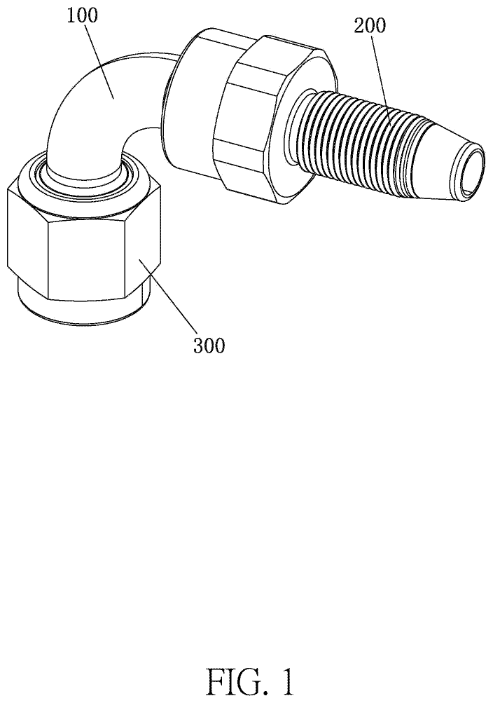

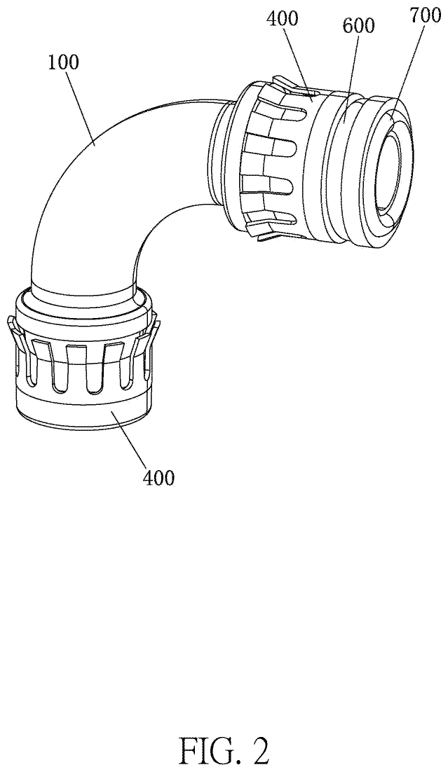

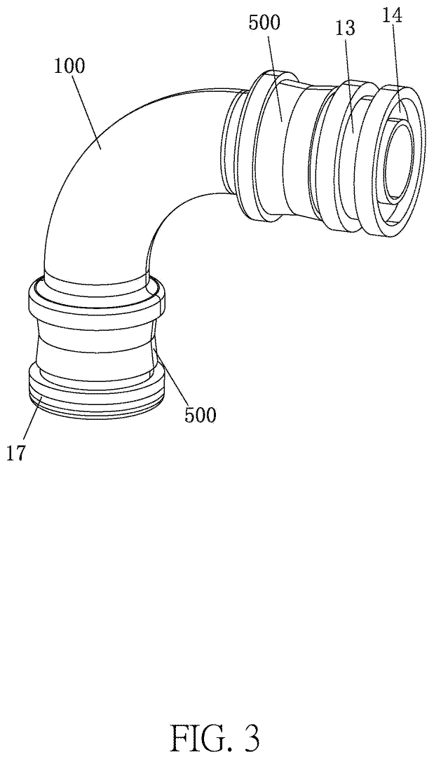

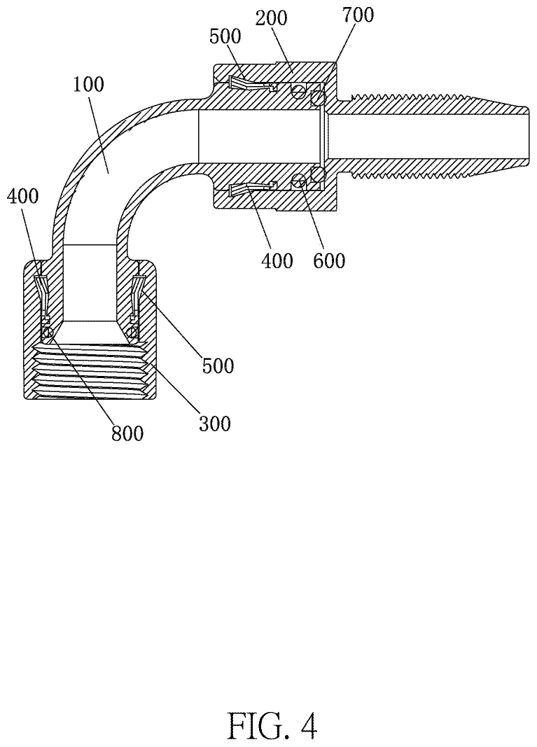

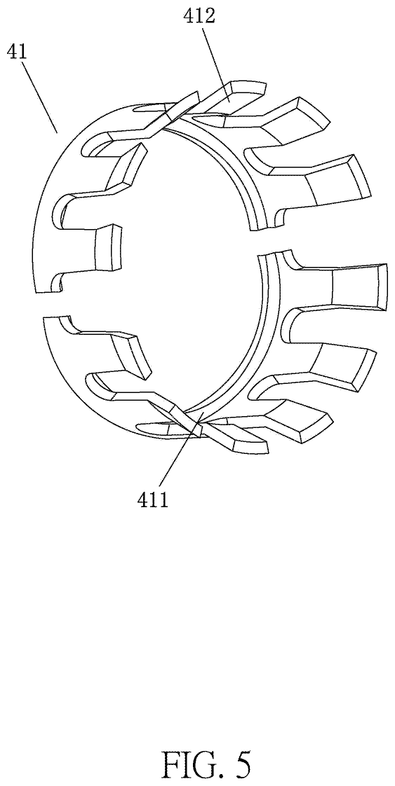

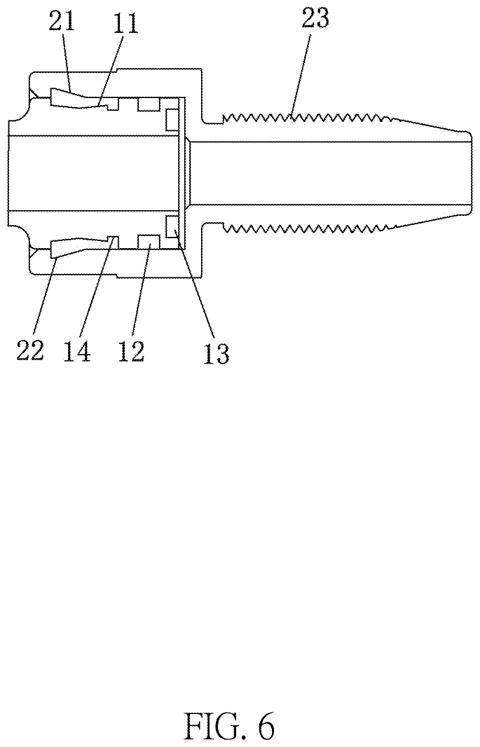

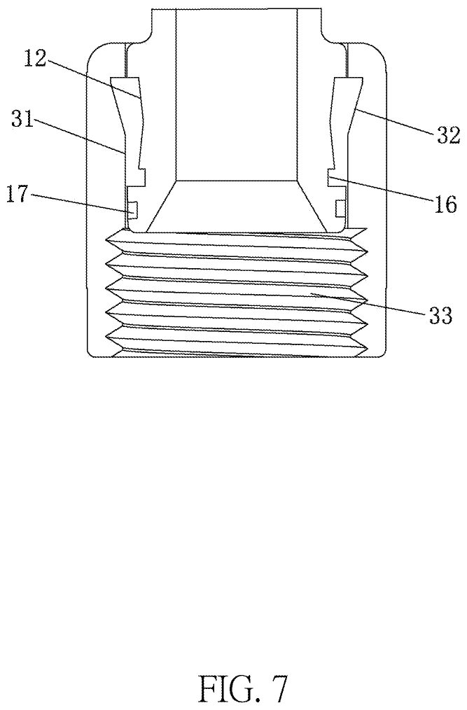

Referring to FIGS. 1 to 7, an embodiment of the present invention presents an oil tubing connector with good sealing performance, comprising a tube body 100, an oil nozzle 200, and a connector head 300. A first connection structure is provided between the tube body 100 and the oil nozzle 200, with the oil nozzle 200 being snap-fitted to one end of the tube body 100 via the first connection structure. A second connection structure is provided between the tube body 100 and the connector head 300, with the connector head 300 being snap-fitted to the other end of the tube body 100 through the second connection structure. Both the first and the second connection structures include a snap-fit component 400 and a snap-fit slot 500, where the snap-fit component 400 is composed of two or more snap-fit pieces 41. The snap-fit slot 500 of the first connection structure is formed by a first groove 11 on the tube body 100 and a second groove 21 on the oil nozzle 200, while the snap-fit slot 500 of the second connection structure is formed by a third groove 12 on the tube body 100 and a fourth groove 31 on the connector head 300. The first connection structure also includes a first seal groove 13, a first sealing ring 600, a second seal groove 14, and a first sealing element 700, with the first seal groove 13 located on the tube body 100 and the second seal groove 14 located on the tube body 100 or the oil nozzle 200.

It is noted that the structural design of the snap-fit component 400, composed of two or more snap-fit pieces 41, facilitates installation, allowing the snap-fit component 400 to smoothly cover the tube body. If the snap-fit component 400 were a single piece, it could not be snap-fitted onto the outer surface of the tube body 100. The snap-fit component 400 can be made of metal material or non-metal material (nylon, plastic, etc.).

In one embodiment, the first sealing ring 600 is fitted at the first seal groove 13, forming a first sealing structure between the tube body 100 and the oil nozzle 200.

In another embodiment, the first sealing element 700 includes any of the following: a second sealing ring, a sealing gasket, or a sealing sleeve.

In another embodiment, the second sealing ring, sealing gasket, or sealing sleeve is placed in the second seal groove 14, forming a second sealing structure between the tube body 100 and the oil nozzle 200.

It is emphasized that by adopting the snap-fit component 400 and snap-fit slot 500 fixing structure to replace the original pin and pinhole fixing structure, the processing steps are reduced, manufacturing costs and assembly difficulty are lowered, and installation is facilitated. At the same time, the sealing performance of the tube body 100, the oil nozzle 200, and the connector head 300 is improved. Additionally, on the basis of the original first seal groove 13 and first sealing ring 600 on the tube body 100 or oil nozzle 200, a second seal groove 14 is added. A sealing ring, sealing gasket, or sealing sleeve is placed in the second seal groove 14 for secondary sealing. The connection design of the snap-fit component 400 and snap-fit slot 500 results in a compact connection between the tube body 100 and the oil nozzle 200, ensuring consistency and integrity, significantly improving the sealing performance between the tube body 100 and the oil nozzle 200. The sealing effect is enhanced, effectively preventing oil spills from the gaps between the tube body 100 and the oil nozzle 200, offering strong practicality.

In another embodiment, the snap-fit component 400 has a petal-like structure, with the snap-fit pieces 41 including an L-shaped insertion part 411 and a bending part 412, where the bending part 412 extends outward.

In one of the embodiments, the snap-fit piece 41 is an elastic metal sheet. This design, where the snap-fit component 400 has a petal-like structure with bending parts 412 extending outward, effectively secures the connection between the tube body 100 and the oil nozzle 200 or between the tube body 100 and the connector head 300. The use of elastic metal for the snap-fit piece 41 facilitates better assembly and engagement.

In this embodiment, the first groove 11 is located on the outer surface of the tube body 100, and the second groove 21 is located on the inner surface of the oil nozzle 200. The first groove 11 includes an inward-facing first limiting slot 14, into which the protruding part of the L-shaped insertion portion 411 of the snap-fit piece 41 fits. The second groove 21 includes an outward-facing second limiting slot 22, where the bending part 412 is positioned.

It is noted that during the installation of the oil nozzle 200 onto the tube body 100, the snap-fit piece 41 is first wrapped around the exterior of the tube body 100. The installer applies pressure through the oil nozzle 200 on the snap-fit piece 41, causing the bending part 412, due to its elastic properties, to contract inward, allowing the snap-fit piece 41 to enter the snap-fit slot 500 smoothly. Once the oil nozzle 200 and the tube body 100 are assembled, the bending part 412 of the snap-fit piece 41, due to its elasticity, springs outward into the second limiting slot 22, thereby securing the connection between the tube body 100 and the oil nozzle 200.

Similarly, for the connection between the connector head 300 and the tube body 100, the third groove 12 is located on the outer surface of the tube body 100, and the fourth groove 31 is located on the inner surface of the connector head 300. The third groove 12 includes an inward-facing third limiting slot 16, where the protruding part of the L-shaped insertion portion 411 fits. Upon installation, the bending part 412 contracts due to pressure applied through the connector head 300, allowing the snap-fit piece 41 to enter the snap-fit slot 500. Once assembled, the bending part 412 springs outward into the fourth limiting slot 32, securing the connection between the connector head 300 and the tube body 100.

In another embodiment, the second connection structure includes a third seal groove 17 and a third sealing ring 800, with the third seal groove 17 located on the tube body 100. The third sealing ring 800 is fitted over the third seal groove 17, creating a third sealing structure between the tube body 100 and the connector head 300.

Additionally, in one of the embodiments, the outer surface of the oil nozzle 200 is provided with external threads 23, and the inner surface of the connector head 300 is provided with internal threads 33.

It is apparent to those skilled in the art that the invention is not limited to the details of the foregoing exemplary embodiments and that the invention can be embodied in other specific forms without departing from the spirit or essential attributes thereof. Therefore, the embodiments should be considered in all respects as illustrative and not restrictive. The scope of the invention is defined by the appended claims rather than the foregoing description, and all changes that come within the meaning and range of equivalency of the claims are therefore intended to be embraced therein. Any reference signs in the claims should not be construed as limiting the claim concerned.

Furthermore, it should be understood that although the description is drafted according to embodiments, not every embodiment includes only one independent technical solution, and the description is made for clarity. Those skilled in the art should consider the specification as a whole, and the technical solutions in the various embodiments may also be appropriately combined to form other embodiments understood by those skilled in the field.

I claim:

1. An oil tubing connector, comprising:
a tube body, an oil nozzle, and a connector head;
a first connection structure disposed between the tube body and the oil nozzle, with the oil nozzle being snap-fitted to one end of the tube body through the first connection structure;
a second connection structure disposed between the tube body and the connector head, with the connector head being snap-fitted to the other end of the tube body through the second connection structure;
wherein both the first and second connection structures include a snap-fit component and a snap-fit slot, with the snap-fit component being composed of two or more snap-fit pieces;
the snap-fit slot of the first connection structure is formed by a first groove on the tube body and a second groove on the oil nozzle, while the snap-fit slot of the second connection structure is formed by a third groove on the tube body and a fourth groove on the connector head;
the first connection structure also includes a first seal groove, a first sealing ring, a second seal groove, and a first sealing element, with the first seal groove located on the tube body and the second seal groove located on either the tube body or the oil nozzle.

2. The oil tubing connector according to claim 1, wherein the first sealing ring is fitted at the first seal groove, forming a first sealing structure between the tube body and the oil nozzle.

3. The oil tubing connector according to claim 2, wherein the first sealing element includes any of the following: a second sealing ring, a sealing gasket, or a sealing sleeve.

4. The oil tubing connector according to claim 2, wherein the second sealing ring, sealing gasket, or sealing sleeve is placed in the second seal groove, forming a second sealing structure between the tube body and the oil nozzle.

5. The oil tubing connector according to claim 1, wherein the snap-fit component has a petal-like structure, with the snap-fit pieces including an L-shaped insertion part and a bending part, where the bending part extends outward.

6. The oil tubing connector according to claim 5, wherein the snap-fit pieces are made of elastic metal.

7. The oil tubing connector according to claim 6, wherein the first groove is located on the outer surface of the tube body, and the second groove is located on the inner surface of the oil nozzle;
the first groove includes an inward-facing first limiting slot, into which the protruding part of the L-shaped insertion part fits;
the second groove includes an outward-facing second limiting slot, where the bending part is positioned.

8. The oil tubing connector according to claim 6, wherein the third groove is located on the outer surface of the tube body, and the fourth groove is located on the inner surface of the connector head;
the third groove includes an inward-facing third limiting slot, into which the protruding part of the L-shaped insertion part fits;
the fourth groove includes an outward-facing fourth limiting slot, where the bending part is positioned.

9. The oil tubing connector according to claim 1, wherein the second connection structure also includes a third seal groove and a third sealing ring, with the third seal groove located on the tube body and the third sealing ring fitted on the tube body, forming a third sealing structure between the tube body and the connector head.

10. The oil tubing connector according to claim 1, wherein the outer surface of the oil nozzle is provided with external threads, and the inner surface of the connector head is provided with internal threads.
